(19) United States
(12) Patent Application Publication
(10) Pub. No.: US 2024/0347240 A1
(43) Pub. Date: Oct. 17, 2024

(54) MnBi-based magnet

(71) Applicants: LG INNOTEK CO., LTD., Seoul (KR); UNIVERSITY OF TSUKUBA, Ibaraki (JP)

(72) Inventors: Hyunseok LIM, Seoul (KR); Seok Bae, Seoul (KR); Yuto Morishita, Kanagawa-ken (JP); Yosuke Harashima, Ibaraki (JP); Yasuteru Shigeta, Ibaraki (JP); Masafuyu Matsui, Ibaraki (JP); Rie Umetsu, Miyagi (JP)

(21) Appl. No.: 18/637,555

(22) Filed: Apr. 17, 2024

(30) Foreign Application Priority Data
Apr. 17, 2023 (KR) 10-2023-0050115

(51) Int. Cl. H01F 1/047

(52) U.S. Cl. CPC H01F 1/047

(57) ABSTRACT

A MnBi-based magnet according to an embodiment includes crystal grains of (MnBi)ₐM_{b} composition including a manganese element, a bismuth and a M element, wherein the M element is contained an amount of more than 0 at % and less than or equal to 10 at % when at % for all atoms of (MnBi)ₐM_{b} is 100 at %, and the M element includes a chromium element, a germanium element, or a tellurium element.

### CROSS-REFERENCE TO RELATED APPLICATIONS

This application is based on and claims priority under 35 U.S.C. § 119 to Korean Patent Application No. 10-2023-0050115, filed on Apr. 17, 2023, in the Korean Intellectual Property Office, which is hereby incorporated by reference in its entirety.

### BACKGROUND

### 1. Field

An embodiment relates to a MnBi-based magnet.

### 2. Description of the Related Art

A neodymium magnet (Nd—Fe—B) is a strongest magnet used industrially. The neodymium magnet is applied to a HDD, a speaker, a mobile phone, an automobile, and a robot. A coercive force of the neodymium magnet decreases as a temperature rises. Accordingly, dysprosium (Dy) is added to the neodymium magnet and used. As a result, the neodymium magnet can maintain high coercive force even at high temperatures. However, dysprosium is an expensive substance. Accordingly, there is a demand for permanent magnet materials that substitute the neodymium magnet and do not contain rare earth elements.

A MnBi-based magnet is a permanent magnet that do not contain rare earth elements and were discovered more than 60 years ago. However, the MnBi-based magnet has not been put into practical use because its performance as a permanent magnet is not sufficient or there are problems with corrosion resistance.

In detail, there is a maximum energy product (BH)max as an indicator of magnetic properties of a permanent magnet. The neodymium magnet has a maximum energy product (BH)max of 40MGOe or more at room temperature. However, the coercive force and magnetization of the neodymium magnet decrease as the temperature increases.

Accordingly, the maximum energy product (BH) of the neodymium magnet decreases by more than 50% at a temperature of about 150° C.

On the other hand, the MnBi-based magnet has the unique property of increasing coercive force as the temperature rises. Theoretically, the maximum energy product (BH) of the MnBi-based magnet is higher than that of the neodymium magnet at a temperature of about 150° C. Because the MnBi-based magnet does not contain rare earth elements, it has recently drawn attention again as a research subject.

However, theoretically, the maximum energy product (BH)max of the MnBi-based magnet at room temperature is 17.7 MGOe, which is much smaller than the maximum energy product (BH)max of the neodymium magnet. In addition, the MnBi-based magnet has properties such as saturation magnetization, residual magnetization, and coercive force at room temperature, which are smaller than those of the neodymium magnet.

Therefore, the MnBi-based magnet having improved properties even in a room temperature range is required.

There is a Korean registered patent (KR10-1585478) as prior art related to the MnBi-based magnet.

### SUMMARY

The embodiment provides a MnBi-based magnet with improved magnetic properties in the room temperature range.

A MnBi-based magnet according to an embodiment comprises crystal grains of (MnBi)aMb composition including a manganese element, a bismuth and a M element, wherein the M element is contained an amount of more than 0 at % and less than or equal to 10 at % when at % for all atoms of (MnBi)aMb is 100 at %, and the M element includes a chromium element, a germanium element, or a tellurium element.

In addition, when at % for all atoms of MnBi is 100 at %, the manganese element in the MnBi contains 45 at % to 65 at %, the bismuth element in the MnBi contains 35 at % to 55 at %, and the at % of the manganese element is greater than the at % of the bismuth element.

In addition, the MnBi-based magnet includes a low temperature phase (LTP) of 40 wt % to 70 wt %.

In addition, the M element includes a chromium element, and the chromium element is contained in an amount of more than 0 at % and less than or equal to 6 at %.

In addition, the MnBi-based magnet has a saturation magnetization of 70 emu/g to 80 emu/g at a temperature of 300 K when the low-temperature phase is converted to 100 wt %.

In addition, the M element includes a germanium element, and the germanium element is contained in an amount of more than 0 at % and less than or equal to 4 at %.

In addition, the MnBi-based magnet has a saturation magnetization of 70 emu/g to 80 emu/g at a temperature of 300 K when the low temperature phase is converted to 100 wt %.

In addition, the M element includes tellurium element, and the tellurium element is contained in an amount of more than 0 at % and less than or equal to 3 at %.

In addition, the MnBi-based magnet has a saturation magnetization of 69 emu/g to 80 emu/g at a temperature of 300 K when the low-temperature phase is converted to 100 wt %.

Meanwhile, a MnBi-based magnet according to an embodiment comprises crystal grains of (MnBi)aMb composition including a manganese element, a bismuth and a M element, wherein an atomic radius of the M element is smaller than the atomic radius of the bismuth element, and a difference between the atomic radius of the M element and the atomic radius of the bismuth element is 0.15 Å to 0.36 Å.

In addition, a difference between the atomic radius of the M element and an atomic radius of the manganese element is 0.07 Å to 0.11 Å.

In addition, the M element is substituted with the bismuth element.

In addition, the M element includes a chromium element, a germanium element, or a tellurium element.

In addition, the MnBi-based magnet includes a low temperature phase (LTP) of 40 wt % to 70 wt %.

In addition, the M element is contained an amount of more than 0 at % and less than or equal to 10 at % when at % for all atoms of (MnBi)aMb is 100 at %.

The MnBi-based magnet according to the embodiment includes an element added to or substituted for the MnBi-based magnet. That is, the MnBi-based magnet is formed by adding or substituting a M element to (MnBi)aMb.

A volume of a unit cell of a low temperature phase (LTP), which is a main component of the MnBi-based magnet and has a ferromagnetic phase, is reduced by substitution or addition of the M element. Accordingly, a saturation magnetization of the low-temperature phase of the MnBi-based magnet increases.

In detail, an atomic radius of the M element is similar to an atomic radius of the manganese element or an atomic radius of the bismuth element. Additionally, at % of the M element is contained in a setting range.

Therefore, the MnBi-based magnet with M element added to the MnBi-based magnet or the MnBi-based magnet in which the manganese element or the bismuth element of the MnBi-based magnet is substituted with the M element has a low temperature phase of 40 wt % or more. Additionally, the MnBi-based magnet has a higher saturation magnetization than the MnBi magnet at a room temperature range.

Therefore, the MnBi-based magnet according to the embodiment has high magnetic properties at room temperature. Therefore, the embodiment provides a MnBi-based magnet so that the magnet can be used at low cost without containing separate rare earth elements.

### BRIEF DESCRIPTION OF THE DRAWINGS

FIG. 1 is a graph showing atomic radii of elements for selecting substitution elements or addition elements for a MnBi-based magnet according to an embodiment.

FIG. 2 is a graph showing magnetization properties of a MnBi-based magnet measured through DFT (Density Functional Theory) calculation to select a substitution element or addition element for a MnBi-based magnet according to an embodiment.

FIG. 3 is a graph showing a formation energy of a MnBi-based magnet for selecting a substitution element or addition element of a MnBi-based magnet according to an embodiment.

FIGS. 4 to 6 are graphs of X-ray diffraction patterns when amounts of chromium, germanium, and tellurium elements added to the MnBi-based magnet are changed.

FIGS. 7 to 9 are graphs of magnetic properties when amounts of chromium, germanium, and tellurium elements added to MnBi-based magnets are changed.

### DETAILED DESCRIPTION

Hereinafter, embodiments of the present invention will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and replaced.

In addition, unless expressly otherwise defined and described, the terms used in the embodiments of the present invention (including technical and scientific terms may be construed the same meaning as commonly understood by one of ordinary skill in the art to which this invention belongs, and the terms such as those defined in commonly used dictionaries may be interpreted as having a meaning that is consistent with their meaning in the context of the relevant art. Further, the terms used in the embodiments of the present invention are for describing the embodiments and are not intended to limit the present invention.

Hereinafter, a MnBi-based magnet according to an embodiment will be described with reference to the drawings.

### MnBi-Based Magnet

A MnBi-based magnet according to the embodiment includes (MnBi)aMb (a and b are positive numbers). In detail, the MnBi-based magnet is formed by substituting or adding M element to the MnBi magnet.

The MnBi magnet may contain 35 at % to 65 at % of the manganese element and 35 at % to 65 at % of the bismuth element. In detail, the MnBi magnet may contain 45 at % to 65 at % of the manganese element and 35 at % to 55 at % of the bismuth element.

Additionally, in the MnBi magnet, the at % of the manganese element may be greater than the at % of the bismuth element. The at % of the manganese element and the bismuth element is based on the at % of all atoms of MnBi being 100 at %.

The MnBi-based magnet may contain a M element within a set range. In detail, the MnBi-based magnet having crystal grains of the composition (MnBi)aMb may contain more than 0 at % and less than or equal to 10 at % of the M element. More specifically, the MnBi-based magnet may contain more than 0 at % and less than or equal to 8 at % of the M element. More specifically, the MnBi-based magnet may contain more than 0 at % and less than or equal to 6 at % of the M element. The at % of the M element is based on the at % of all atoms of (MnBi)aMb being 100 at %.

The MnBi-based magnet may have a low temperature phase within a set wt % range. In detail, the MnBi-based magnet may have a low temperature phase (LTP) of 40 wt % or more. More specifically, the MnBi-based magnet may have a low temperature phase of 40 wt % to 70 wt %. More specifically, the MnBi-based magnet may have a low temperature phase of 45 wt % to 68 wt %. Here, the wt % of the low-temperature phase is based on the wt % of all phases of the MnBi-based magnet being 100 wt %.

An atomic radius of the M element has a set size. The atomic radius of the M element is related to an atomic radius of the manganese element and an atomic radius of the bismuth element.

The atomic radius of the M element is different from the atomic radius of the bismuth element. In detail, the atomic radius of the M element is smaller than the atomic radius of the bismuth.

Additionally, the atomic radius of the M element is different from the atomic radius of the manganese element. In detail, the atomic radius of the M element is smaller than the atomic radius of the manganese element. Alternatively, the atomic radius of the M element is greater than the atomic radius of the manganese element.

Accordingly, the atomic radius of the M element may be smaller than the atomic radius of the manganese element and the atomic radius of the bismuth element.

Alternatively, the atomic radius of the M element may be between the atomic radius of the manganese element and the atomic radius of the bismuth element.

A difference between the atomic radius of the M element and the atomic radius of the bismuth element may be 0.1 Å (angstrom) or more. In detail, the difference between the atomic radius of the M element and the atomic radius of the bismuth element may be 0.1 Å to 0.5 Å. More specifically, the difference between the atomic radius of the M element and the atomic radius of the bismuth element may be 0.1 Å to 0.4 Å. More specifically, the difference between the atomic radius of the M element and the atomic radius of the bismuth element may be 0.15 Å to 0.36 Å.

Additionally, a difference between the atomic radius of the M element and the atomic radius of the manganese element may be 0.2 Å (angstrom) or less. In detail, the difference between the atomic radius of the M element and the atomic radius of the manganese element may be 0.05 Å to 0.2 Å. More specifically, the difference between the atomic radius of the M element and the atomic radius of the manganese element may be 0.06 Å to 0.15 Å. More specifically, the difference between the atomic radius of the M element and the atomic radius of the manganese element may be 0.07 Å to 0.11 Å.

Accordingly, the atomic radius of the M element may be similar to the atomic radius of at least one of the manganese element and the bismuth element. In detail, the atomic radius of the M element may be similar to the atomic radius of the manganese element and the atomic radius of the bismuth element.

The MnBi-based magnet contains a low-temperature phase with ferromagnetism as its main component. A crystal structure of the low-temperature phase refers to a NiAs-type crystal structure with crystal grains of a stoichiometric composition of Mn:Bi=1:1.

A magnetization of the low-temperature phase of the MnBi-based magnet is calculated as a magnetic moment per volume of a unit cell. Therefore, when a volume of the unit cell of the crystal structure of the low-temperature phase of the MnBi-based magnet decreases, a magnetization of the low-temperature phase of the MnBi-based magnet increases. Alternatively, when the magnetic moment of the low-temperature phase of the MnBi-based magnet increases, the magnetization of the low-temperature phase of the MnBi-based magnet increases. Accordingly, the magnetic properties of the MnBi-based magnet are improved.

When the M element having an atomic radius smaller than the atomic radius of the manganese element is substituted with the manganese element, the volume of the unit cell of the low-temperature crystal structure of the MnBi-based magnet may become smaller. Accordingly, the magnetization of the low-temperature phase of the MnBi-based magnet may increase.

Alternatively, when the M element having an atomic radius smallerthan the atomic radius of the bismuth element is substituted with the bismuth element, the volume of the unit cell of the low-temperature crystal structure of the MnBi-based magnet may become smaller. Accordingly, the magnetization of the low-temperature phase of the MnBi-based magnet may increase.

In the MnBi-based magnet according to the embodiment, the M element having an atomic radius smaller than the atomic radius of the manganese element may be substituted for the manganese atom. Accordingly, the volume of the unit cell of the low-temperature phase crystal structure of the MnBi-based magnet may be decreased.

Accordingly, the magnetization of the low-temperature phase of the MnBi-based magnet may increase.

Alternatively, in the MnBi-based magnet according to the embodiment, an M element having an atomic radius smaller than the atomic radius of the bismuth element may be substituted for the bismuth atom. Accordingly, the volume of the unit cell of the low-temperature phase unit crystal of the MnBi-based magnet may be reduced.

Accordingly, magnetization of the low-temperature phase of the MnBi-based magnet may increase.

The M element is selected according to the method for determining substitution or addition elements described below. For example, the atomic radius of the M element may be smaller than the atomic radius of the manganese element and the atomic radius of the bismuth element. For example, the M element includes chromium (Cr) and germanium (Ge).

Alternatively, the atomic radius of the M element may be greater than the atomic radius of the manganese element and smaller than the atomic radius of the bismuth element. For example, the M element includes tellurium element (Te).

The chromium element (Cr), the germanium element (Ge), and the tellurium element (Te) may be substituted with at least one of the manganese element and the bismuth element.

Therefore, the MnBi-based magnet having crystal grains with a composition of (MnBi)aMb may have crystal grains with a composition of Mn1-xBiMx or MnBi1-xMx in the low-temperature phase by the addition M element substituting the manganese element or bismuth element. Additionally, ‘a’, ‘b’, and ‘x’ are positive numbers, and a>b is satisfied. Additionally, the M element may be substituted with at least one of the manganese element and the bismuth element. The M element includes chromium (Cr), germanium (Ge), or tellurium (Te).

### Determination of Substitution or Addition Elements for MnBi-Based Magnet

The M element, which is a substitution or addition element of the MnBi-based magnet, is determined through an atomic radius of an element, magnetization characteristics of the MnBi-based magnet measured through DFT (Density Functional Theory) calculation, and a formation energy of the MnBi-based magnet.

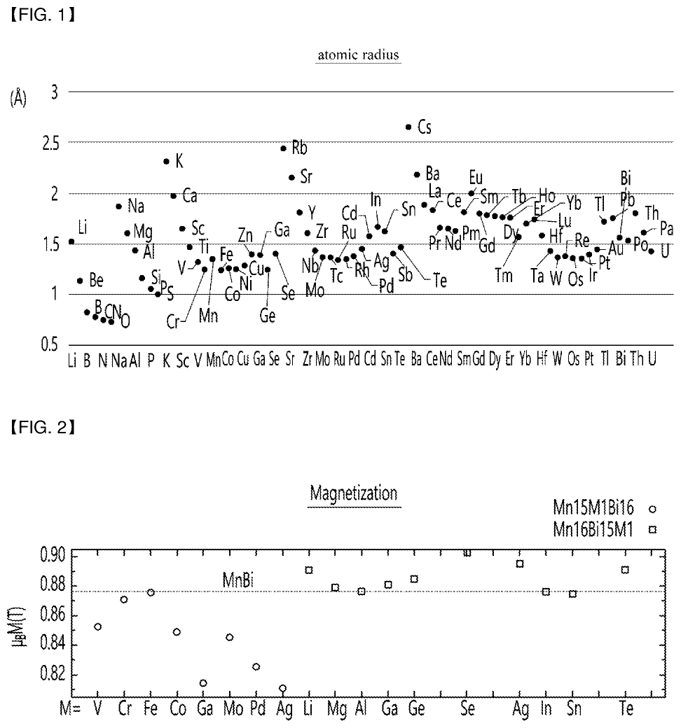

FIG. 1 is a graph of atomic radii of elements for selecting a M element.

The atomic radius of the bismuth element is greater than the atomic radius of the manganese element.

Therefore, elements with an atomic radius greater than the atomic radius of the bismuth element are excluded from a candidate group of M elements. Additionally, elements having atomic radii similar to an atomic radius of the bismuth element and an atomic radius of the manganese element are selected as the candidate group. In detail, elements having a difference of 0.15 Å to 0.36 Å from the atomic radius of the bismuth element are selected as elements of a first candidate group. Additionally, elements having an atomic radius difference of 0.07 Å to 0.11 Å from the atomic radius of the manganese element are selected as elements of a first candidate group.

Next, elements of a second candidate group, which are elements of a final candidate group, are selected from the elements of the first candidate group based on the magnetization characteristics of the MnBi-based magnet and the formation energy of the MnBi-based magnet measured through DFT (Density Functional Theory) calculation.

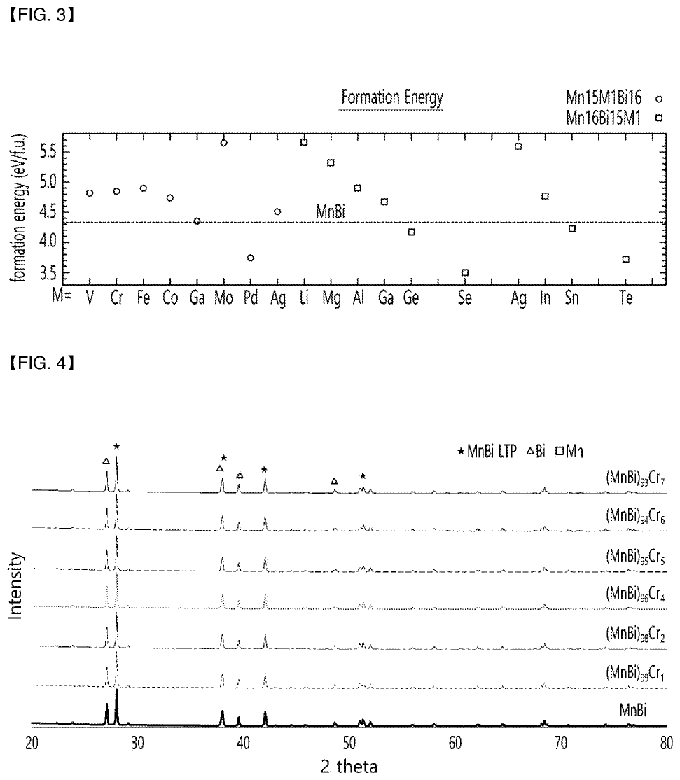

FIG. 2 is a graph showing magnetization properties of a MnBi-based magnet measured through DFT (Density Functional Theory) calculation to select a substitution element or addition element for a MnBi-based magnet according to an embodiment, and FIG. 3 is a graph showing a formation energy of a MnBi-based magnet for selecting a substitution element or addition element of a MnBi-based magnet according to an embodiment.

In FIGS. 2 and 3, circles (o) represent the magnetization characteristics and the formation energy when substituting the elements of the first candidate group with the manganese element. In addition, squares (Q) in FIGS. 2 and 3 represent the magnetization characteristics and the formation energy when substituting the elements of the first candidate group with the bismuth element.

Referring to FIG. 2, the magnetization characteristics of the MnBi-based magnet in which lithium element (Li), magnesium element (Mg), gallium element (Ga), germanium element (Ge), selenium element (Se), silver element (Ag), and tellurium element (Te) are substituted with the bismuth element are greater than the magnetization characteristics of the MnBi magnet.

In addition, the magnetization characteristics of the MnBi-based magnet in which aluminum element (AI), indium element (In), and tin element (Sn) are substituted with the bismuth element are smaller than the magnetization characteristics of the MnBi magnet.

In addition, the magnetization characteristics of the MnBi-based magnet in which vanadium element (V), chromium element (Cr), iron element (Fe), cobalt element (Co), gallium element (Ga), molybdenum element (Mo), palladium element (Pd), and silver element (Ag) are substituted with the bismuth element are smaller than the magnetization characteristics of the MnBi magnet.

Referring to FIG. 3, the formation energy of the MnBi-based magnet in which lithium element (Li), magnesium element (Mg), aluminum element (AI), gallium element (Ga), silver element (Ag), and indium element (In) are substituted with the bismuth element are greater than the formation energy of the MnBi magnet.

In addition, the formation energy of the MnBi-based magnet in which germanium element (Ge), selenium element (Se), tin element (Sn), and tellurium element (Te) are substituted with the bismuth element are smaller than the formation energy of the MnBi magnet.

In addition, the formation energy of the MnBi-based magnet in which vanadium element (V), chromium element (Cr), iron element (Fe), cobalt element (Co), gallium element (Ga), molybdenum element (Mo), and silver element (Ag) element are substituted with the manganese element are greater than the formation energy of the MnBi magnet.

In addition, the formation energy of the MnBi-based magnet in which the palladium element (Pd) is substituted with the manganese element is smaller than the formation energy of the MnBi magnet.

Referring to FIGS. 1 to 3, germanium element (Ge), tellurium element (Te), and chromium element (Cr) are selected as elements of the second candidate group, which are elements of the final candidate group.

When the germanium element (Ge) and the tellurium element (Te) are substituted with the bismuth element, the magnetization characteristics of the MnBi-based magnet are high, the formation energy characteristics of the MnBi-based magnet is low. Therefore, the germanium element (Ge) and the tellurium element (Te) can be selected as the elements of the second candidate group.

In addition, when the chromium element (Cr) is substituted with the manganese element, the magnetization characteristics of the MnBi-based magnet are low and the formation energy of the MnBi-based magnet is high. However, the atomic radius of the chromium element (Cr) is smaller than the atomic radius of the germanium element (Ge) and the atomic radius of the tellurium element (Te). Accordingly, the chromium element (Cr) may be selected as the elements of the second candidate group.

The lithium element (Li), the gallium element (Ga), and the silver element (Ag) are excluded from the elements of the second candidate group because the formation energy of the MnBi-based magnet is high.

The selenium element (Se) is toxic, and accordingly, the selenium element (Se) can be excluded from the elements of the second candidate group.

The magnesium element (Mg) has a high formation energy, so the magnesium element can be excluded from the elements of the second candidate group.

### Experimental Example of MnBi-Based Magnet

A saturation magnetization of the MnBi-based magnet in which the MnBi magnet was substituted with elements selected from the elements of the second candidate group was calculated.

### Experimental Example 1

A mixture was prepared using Mn, Bi, and Cr as raw materials. Next, the mixture was placed in a ceramic crucible and heated and melted in an Ar atmosphere at a temperature of about 1200° C., and then a molten metal was transferred to a metal mold to obtain an ingot. The ingot was homogenized by annealing at a temperature range of 280° C. to 320° C. for 48 hours. Next, the annealed ingot was pulverized into powder.

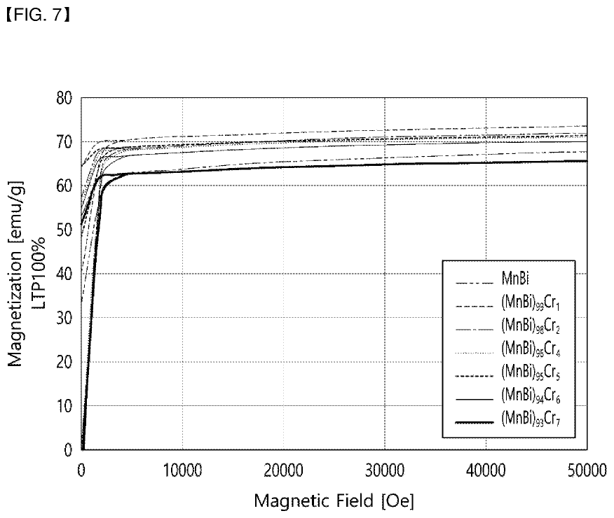

The powder was measured using an X-ray diffraction device (Rigaku, Smart-lab). FIG. 4 shows an X-ray diffraction pattern when chromium element is added. It can be confirmed from the X-ray diffraction pattern that the produced MnBi-based magnet contains a Bi phase and a small amount of Mn phase in addition to the low-temperature phase that exhibits ferromagnetism. A weight ratio of the low-temperature phase, which is a magnetic phase, was calculated by Rietveld analysis of the X-ray diffraction pattern. Additionally, a cell volume of the low-temperature phase was calculated from a cell constant of the low-temperature phase obtained from Rietveld analysis. Additionally, magnetization was measured on the powder using SQUID (Magnetic Property Measurement System, Quantum Design). FIG. 7 shows magnetic measurement results when chromium element is added. At this time, the magnetization in a magnetic field (5T) is an actual measured value of the saturation magnetization, and the saturation magnetization difference due to the difference in the ratio of the low temperature phase must be removed. For this purpose, the saturation magnetization was calculated in terms of 100 wt % of the low-temperature phase by multiplying the actual saturation magnetization value by the reciprocal of the low-temperature phase ratio. Table 1 shows the low-temperature phase weight ratio, cell volume, and saturation magnetization of each composition. It can be confirmed that the saturation magnetization of the composition in which chromium element is added up to 6 at % is improved compared to MnBi. In addition, it can be confirmed that the cell volume of the low-temperature phase of the composition in which up to 6 at % of chromium element is added is smaller than the cell volume of the low-temperature phase of MnBi. The atomic radii of the elements manganese, bismuth, and chromium are 1.35 A, 1.60 A, and 1.25 A, respectively. As a result of substituting the chromium element with either a manganese element or a bismuth element, it is assumed that the cell volume becomes smaller and the saturation magnetization is improved by the cell volume reduction effect. If the addition amount is 7 at % or more, the cell volume becomes larger than that of MnBi and the saturation magnetization decreases, so it is preferable that the chromium element is 6 at % or less.

### Experimental Example 2

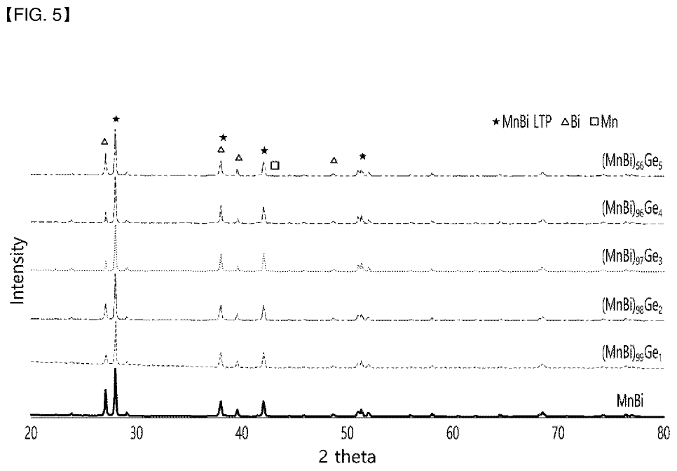

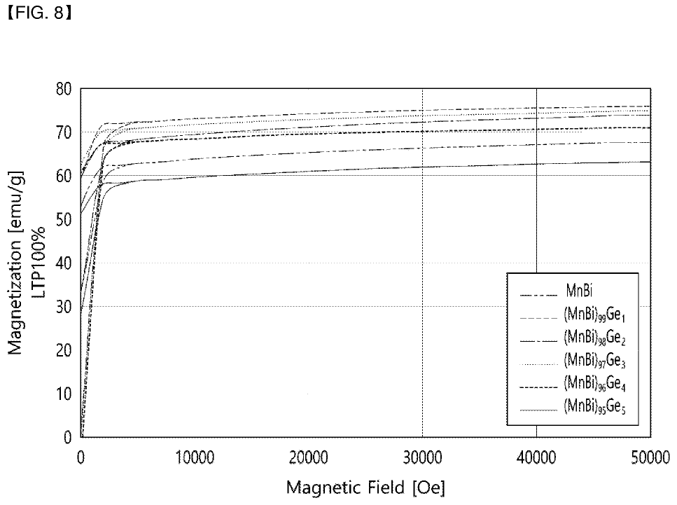

Powder was prepared in the same manner as in Experimental Example 1, except that Mn, Bi, and Ge were used as raw materials and mixed. Then, the saturation magnetization and cell volume of the powder were calculated. FIGS. 5 and 8 show the X-ray diffraction pattern and magnetic measurement results when germanium element is added. It can be confirmed that the cell volume of the low-temperature phase of the composition in which germanium element is added up to 4 at % is smaller than that of the low-temperature phase of MnBi, thereby improving saturation magnetization. The atomic radii of the elements manganese, bismuth, and germanium are 1.35 A, 1.60 A, and 1.24 A, respectively. As a result of substituting the germanium element with either a manganese element or a bismuth element, it is assumed that the cell volume becomes smaller and the saturation magnetization improves due to the cell volume reduction effect. When an addition amount is 5 at % or more, the cell volume becomes greater than that of MnBi and the saturation magnetization decreases, so it is preferable that the germanium element is 4 at % or less.

### Experimental Example 3

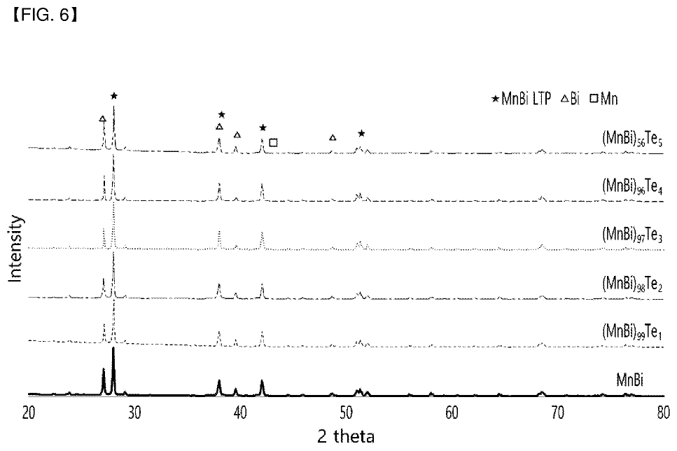

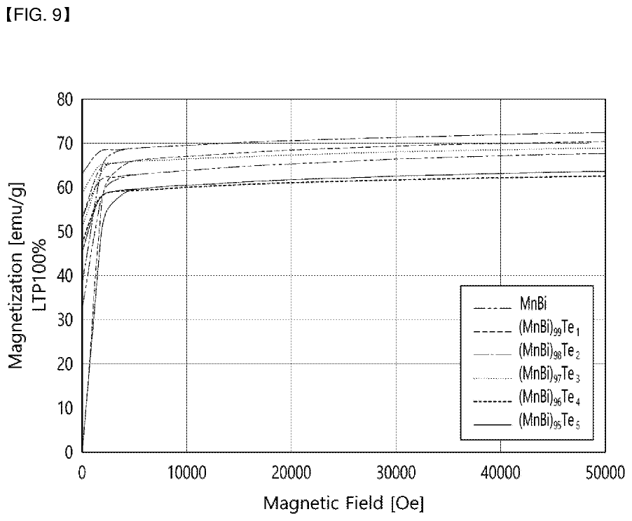

Powder was prepared in the same manner as in Experimental Example 1, except that Mn, Bi, and Te were used as raw materials and mixed. Then, the saturation magnetization and cell volume of the powder were calculated. FIGS. 6 and 9 show the X-ray diffraction pattern and magnetic measurement results when tellurium element is added. It can be configured that the cell volume of the low-temperature phase of the composition in which the tellurium element is added up to 3 at % becomes smaller than that of the low-temperature phase of MnBi, and the saturation magnetization is improved. The atomic radii of the elements manganese, bismuth, and tellurium are 1.35 A, 1.60 A, and 1.45 A, respectively. As a result of substituting the tellurium element with the bismuth element, it is assumed that the cell volume becomes smaller and the saturation magnetization improves due to the cell volume reduction effect. When an addition amount is 4 at % or more, the cell volume becomes greater than that of MnBi and the saturation magnetization decreases, so it is preferable that the tellurium element is 3 at % or less.

### Experimental Example 4

Powder was prepared in the same manner as in Experimental Example 1, except that Mn and Bi were used as raw materials and mixed. Next, the saturation magnetization and cell volume of the powder were calculated.

TABLE 1

| | | | | | Saturation |
|---|---|---|---|---|---|
| | | | | Cell | magnetization |
| | | | | volume | of LTP (emu/g) when |
| | addition | addition | LTP | of LTP | LTP is converted |
| | elements | amount(at %) | (wt %) | (Å³) | to 100 wt %. |
| MnBi | — | — | 64.80 | 97.714 | 67.7 |
| (MnBi)₉₉Cr₁ | Cr | 1 | 71.96 | 97.605 | 71.9 |
| (MnBi)₉₈Cr₂ | Cr | 2 | 65.32 | 97.425 | 73.6 |
| (MnBi)₉₆Cr₄ | Cr | 4 | 61.79 | 97.608 | 71.2 |
| (MnBi)₉₅Cr₅ | Cr | 5 | 52.67 | 97.570 | 71.5 |
| (MnBi)₉₄Cr₆ | Cr | 6 | 57.03 | 97.699 | 70.1 |
| (MnBi)₉₃Cr₇ | Cr | 7 | 64.07 | 97.794 | 65.6 |
| (MnBi)₉₉Ge₁ | Ge | 1 | 75.07 | 97.600 | 76.0 |
| (MnBi)₉₈Ge₂ | Ge | 2 | 67.05 | 97.626 | 73.9 |
| (MnBi)₉₇Ge₃ | Ge | 3 | 80.87 | 97.678 | 75.0 |
| (MnBi)₉₆Ge₄ | Ge | 4 | 76.32 | 97.655 | 71.1 |
| (MnBi)₉₅Ge₅ | Ge | 5 | 58.61 | 97.776 | 63.2 |
| (MnBi)₉₉Te₁ | Te | 1 | 65.38 | 97.686 | 70.4 |
| (MnBi)₉₈Te₂ | Te | 2 | 63.66 | 97.670 | 72.5 |
| (MnBi)₉₇Te₃ | Te | 3 | 65.12 | 97.678 | 69.0 |
| (MnBi)₉₆Te₄ | Te | 4 | 67.92 | 97.785 | 62.6 |
| (MnBi)₉₅Te₅ | Te | 5 | 63.60 | 97.831 | 63.7 |

Table 1 is a table measuring the wt % ratio and saturation magnetization of the low temperature phase (LTP) of MnBi-based magnets according to the at % of substitution or addition elements when chromium element (Cr), germanium element (Ge), and tellurium element (Te) are added to MnBi-based magnet.

Referring to Table 1, it can be confirmed that when chromium (Cr), germanium (Ge), or tellurium (Te) is substituted or added to the MnBi-based magnet, it has improved saturation magnetization compared to the MnBi magnet.

MnBi-based magnets contain a low-temperature phase that exhibits ferromagnetism as a main component. The low-temperature phase may mean crystal grains with a stoichiometric composition of Mn:Bi=1:1. For example, it has a NiAs type crystal structure. When adding a heterogeneous element to a MnBi-based magnet, the heterogeneous element may substitute the manganese element or bismuth element in the low-temperature phase crystal structure, or the heterogeneous element may invade the crystal structure. Here, since the atomic radius of the addition element M is relatively close to the atomic radii of the manganese element and the bismuth element, it is assumed that the added element M has a high possibility of being substituted. In the example, it is assumed that the saturation magnetization of the low-temperature phase of the MnBi-based magnet is changing because there is a possibility that the manganese element or bismuth element constituting the low-temperature phase was substituted by the addition element M, and a change occurred in the cell volume.

For example, a low-temperature phase crystal structure of an MnBi-based magnet having a composition of Mn1-xBiCrx (x is an arbitrary number) or MnBi1-xCrx (x is an arbitrary number) may be formed by substituting the manganese element or the bismuth element with the chromium element (Cr). The low-temperature phase of the (MnBi)aCrb magnet having the above crystal structure has improved saturation magnetization compared to the low-temperature phase of the MnBi magnet. In detail, when the chromium element is included in the (MnBi)aCrb magnet in an amount exceeding 0 at % and less than or equal to 6 at %, the (MnBi)aCrb has a low temperature phase of 40 wt % or more and has improved saturation magnetization compared to the low temperature phase of the MnBi magnet. In detail, the low temperature phase of the ((MnBi)aCrb magnet has a saturation magnetization of more than 70 emu/g at a room temperature range (300K). More specifically, the low temperature phase of the (MnBi)aCrb magnet has a saturation magnetization of 70 emu/g to 80 emu/g at room temperature (300K). Here, the at % of the chromium element is based on the at % of all atoms of (MnBi)aCrb being 100 at %.

Alternatively, the manganese element or the bismuth element may be substituted with the germanium element (Ge) to form a low-temperature crystal structure of the MnBi-based magnet having a composition of Mn1-xBiGex (x is an arbitrary number) or MnBi1-xGex (x is an arbitrary number). The low-temperature phase of the (MnBi)aGeb magnet having the above crystal structure has improved saturation magnetization compared to the low-temperature phase of the MnBi magnet. In detail, when the (MnBi)aGeb magnet contains more than 0 at % and less than or equal to 4 at % of the germanium element, the (MnBi)aGeb has a low-temperature phase of 60 wt % or more and has improved saturation magnetization compared to the low-temperature phase of the MnBi magnet. In detail, the (MnBi)aGeb magnet has a saturation magnetization of more than 70 emu/g at a room temperature range (300K). More specifically, the (MnBi)aGeb magnet has a saturation magnetization of 70 emu/g to 80 emu/g at the room temperature range (300K). Here, the at % of the germanium element is based on the at % of all atoms of (MnBi)aGeb being 100 at %.

Alternatively, the bismuth element may be substituted with the tellurium element (Te) to form a low-temperature crystal structure of the MnBi-based magnet having a composition of MnBi1-xTex (x is an arbitrary number). The low-temperature phase of the (MnBi)aTeb magnet having the above crystal structure has improved saturation magnetization compared to the low-temperature phase of the MnBi magnet. In detail, when the tellurium element is included in the (MnBi)aTeb magnet in an amount exceeding 0 at % and less than or equal to 3 at %, the (MnBi)aTeb has a low temperature phase of more than 60 wt %, and has improved saturation magnetization compared to the low temperature phase of the MnBi magnet. In detail, the (MnBi)aTeb magnet has a saturation magnetization of more than 69 emu/g at room temperature (300K). More specifically, the (MnBi)aTeb magnet has a saturation magnetization of 69 emu/g to 80 emu/g at the room temperature range (300K). Here, the at % of the tellurium element is based on the at % of all atoms of (MnBi)aTeb being 100 at %.

The MnBi-based magnet according to the embodiment includes an element added to or substituted for the MnBi-based magnet. That is, the low-temperature phase crystal structure of the MnBi-based magnet may be formed as (MnBi)aMb, which has a low-temperature phase crystal structure with a composition of Mn1-xBiMx (x is an arbitrary number) or MnBi1-xMx (x is any number) by substituting the M element. That is, the MnBi-based magnet is formed by adding or substituting a M element to (MnBi)aMb.

A volume of a unit cell of a low temperature phase (LTP), which is a main component of the MnBi-based magnet and has a ferromagnetic phase, is reduced by substitution or addition of the M element. Accordingly, a saturation magnetization of the low-temperature phase of the MnBi-based magnet increases.

In detail, an atomic radius of the M element is similar to an atomic radius of the manganese element or an atomic radius of the bismuth element. Additionally, at % of the M element is contained in a setting range.

Therefore, the MnBi-based magnet with M element added to the MnBi-based magnet or the MnBi-based magnet in which the manganese element or the bismuth element of the MnBi-based magnet is substituted with the M element has a low temperature phase of 40 wt % or more. Additionally, the MnBi-based magnet has a higher saturation magnetization than the MnBi magnet at a room temperature range. Therefore, the MnBi-based magnet has a saturation magnetization of 69 emu/g or more at room temperature.

Therefore, the MnBi-based magnet according to the embodiment has high magnetic properties at room temperature. Therefore, the embodiment provides a MnBi-based magnet so that the magnet can be used at low cost without containing separate rare earth elements.

Therefore, the MnBi-based magnet according to the embodiment can be applied to motors for refrigerator and air conditioner compressors, washing machine drive motors, mobile handset vibration motors, speakers, voice coil motors, linear motors for determining a position of a computer hard disk head, motors for camera zoom, aperture, shutter, actuator of micro-processing machine, dual clutch transmission (DCT), electronically controlled braking system (Anti-lock Brake System, ABS), electric power steering (EPS) motor, and automobile electrical components such as fuel pumps due to its excellent magnetic properties.

The characteristics, structures and effects described in the embodiments above are included in at least one embodiment but are not limited to one embodiment.

Furthermore, the characteristics, structures, and effects and the like illustrated in each of the embodiments may be combined or modified even with respect to other embodiments by those of ordinary skill in the art to which the embodiments pertain. Thus, it should be construed that contents related to such a combination and such a modification are included in the scope of the embodiment.

The above description has been focused on the embodiment, but it is merely illustrative and does not limit the embodiment. A person skilled in the art to which the embodiment pertains may appreciate that various modifications and applications not illustrated above are possible without departing from the essential features of the embodiment. For example, each component particularly represented in the embodiment may be modified and implemented. In addition, it should be construed that differences related to such changes and applications are included in the scope of the embodiment defined in the appended claims.

1. A MnBi-based magnet, comprising:
crystal grains of (MnBi)ₐM_{b} composition including a manganese element, a bismuth and a M element,
wherein the M element is contained an amount of more than 0 at % and less than or equal to 10 at % when at % for all atoms of (MnBi)ₐM_{b} is 100 at %, and
wherein the M element includes a chromium element, a germanium element, or a tellurium element.

2. The MnBi-based magnet of claim 1, wherein when at % for all atoms of MnBi is 100 at %,
the manganese element in the MnBi contains 45 at % to 65 at %,
the bismuth element in the MnBi contains 35 at % to 55 at %, and
the at % of the manganese element is greater than the at % of the bismuth element.

3. The MnBi-based magnet of claim 1, wherein the MnBi-based magnet includes a low temperature phase (LTP) of 40 wt % to 70 wt %.

4. The MnBi-based magnet of claim 1, wherein the M element includes a chromium element, and
the chromium element is contained in an amount of more than 0 at % and less than or equal to 6 at %.

5. The MnBi-based magnet of claim 4, wherein the MnBi-based magnet has a saturation magnetization of 70 emu/g to 80 emu/g at a temperature of 300 K when the low-temperature phase is converted to 100 wt %.

6. The MnBi-based magnet of claim 1, wherein the M element includes a germanium element, and
the germanium element is contained in an amount of more than 0 at % and less than or equal to 4 at %.

7. The MnBi-based magnet of claim 6, wherein the MnBi-based magnet has a saturation magnetization of 70 emu/g to 80 emu/g at a temperature of 300 K when the low temperature phase is converted to 100 wt %.

8. The MnBi-based magnet of claim 1, wherein the M element includes tellurium element, and
the tellurium element is contained in an amount of more than 0 at % and less than or equal to 3 at %.

9. The MnBi-based magnet of claim 8, wherein the MnBi-based magnet has a saturation magnetization of 69 emu/g to 80 emu/g at a temperature of 300 K when the low-temperature phase is converted to 100 wt %.

10. A MnBi-based magnet, comprising:
crystal grains of (MnBi)ₐM_{b} composition including a manganese element, a bismuth and a M element,
wherein an atomic radius of the M element is smaller than the atomic radius of the bismuth element, and
wherein a difference between the atomic radius of the M element and the atomic radius of the bismuth element is 0.15 Å to 0.36 Å.

11. The MnBi-based magnet of claim 10, wherein a difference between the atomic radius of the M element and an atomic radius of the manganese element is 0.07 Å to 0.11 Å.

12. The MnBi-based magnet of claim 10, wherein the M element is substituted with the bismuth element.

13. The MnBi-based magnet of claim 10, wherein the M element includes a chromium element, a germanium element, or a tellurium element.

14. The MnBi-based magnet of claim 10, wherein the MnBi-based magnet includes a low temperature phase (LTP) of 40 wt % to 70 wt %.

15. The MnBi-based magnet of claim 10, wherein the M element is contained an amount of more than 0 at % and less than or equal to 10 at % when at % for all atoms of (MnBi)ₐM_{b} is 100 at %.
